(19) United States
(12) Patent Application Publication
(10) Pub. No.: US 2005/0130104 A1
(43) Pub. Date: Jun. 16, 2005

(54) Methods of commissioning and manufacturing customized dental implants

(75) Inventors: Jean Robichaud, Charlesbourg (CA); Marc Beaumier, St-Redempteur (CA)

Correspondence Address: FETHERSTONHAUGH - SMART & BIGGAR, 1000 DE LA GAUCHETIERE WEST, SUITE 3300, MONTREAL, QC, H3B 4W5, CA

(73) Assignee: CENTRE DE RECHERCHE ET DE FORMATION EN IMPLANTOLOGIE

(21) Appl. No.: 10/957,735

(22) Filed: Oct. 5, 2004

Related U.S. Application Data
(60) Provisional application No. 60/528,778, filed on Dec. 12, 2003.

(51) Int. Cl. A61C 8/00

(52) U.S. Cl. 433/173; 433/215

(57) ABSTRACT

A method of commissioning a customized dental implant. Firstly, an electronic representation of an area of interest inside a patient's mouth is obtained. This electronic representation is processed to create data representing a dental implant adapted to fit the area of interest. The data representing the dental implant is delivered to a production facility for remote manufacture of the dental implant.

### FIELD OF THE INVENTION

The present invention relates in general to dental implants.

### BACKGROUND OF THE INVENTION

Dental implants are becoming an increasingly popular option for restoring lost teeth in wholly or partially edentulous patients. Specifically, the restoration of an extracted or lost tooth with the aid of a conventional dental implant typically occurs in several stages. In a first stage, the socket left by the extracted root must heal for a period of three to twelve months. Next, the dentist drills a hole in the bone at the location of the former tooth. Then, the dentist inserts a conventional screw-style implant or cylindrical style implant in the hole. The implant is then left in position for several months until it becomes osseointegrated with the patient's bone. Then, the gum tissue is opened to expose the end of the implant and an artificial tooth is fixed to the implant.

An alternative method is to create a customized implant instead of using a standard implant. Current methods of providing a customized dental implant typically require making a replica of the root of the extracted natural tooth. Specifically, the tooth root is first extracted by the dentist. The extracted tooth root is then sent by messenger to a specially equipped dental laboratory, where it is scanned and reproduced out of a material (e.g., titanium) using an implant milling machine. Subsequently, the implant must be finished manually by a dental technician to add various features such as a base for placing a post to support an artificial tooth, and a special surface finish to enhance gripping. The titanium customized implant is then shipped to the dentist to proceed with insertion in the patient's bone.

### SUMMARY OF THE INVENTION

In accordance with a first broad aspect of the present invention, there is provided a method of commissioning a customized dental implant, comprising: obtaining an electronic representation of an area of interest inside a patient's mouth; processing the electronic representation to create data representing a dental implant adapted to fit the area of interest; and delivering the data representing the dental implant to a production facility for remote manufacture of the dental implant.

In accordance with a second broad aspect of the present invention, there is provided a method for the production of a customized dental implant, comprising: receiving data representing a dental implant via a communications network; and manufacturing a dental implant in accordance with the data representing the dental implant.

In accordance with a third broad aspect, the invention provides a method comprising electronically examining an area inside a patient's mouth to obtain an electronic representation of the area and delivering data derived from the electronic representation to a remote location for use in manufacturing an implant adapted to fit the area.

The step of delivering the data derived from the electronic representation to a remote location encompasses a number of possibilities, some of which will be specifically discussed. Under a first possibility, the data derived from the electronic representation is the raw data generated from a suitable electronic image-gathering device used to electronically examine the area inside the patient's mouth, or a variation of the raw data. By “variation” is meant a treatment of the raw data that can be of any type as long as it preserves the information of the surface features of the area of interest that is necessary to produce an implant that will properly fit the area of interest. Examples of a variation of the raw data include compressing the raw data, encrypting the raw data, translating the data from one type of representation to another type of representation, or performing a pre-processing such as enhancing or cleaning-up the image by any suitable image processing techniques.

The delivery of the data derived from the electronic representation to the remote location can be done via a communications network or by storing the data on a storage medium and transporting the storage medium, by courier, postal service or any other means, to the remote location.

Under a second possibility, the data derived from the electronic representation is data resulting from a processing of the raw data generated from the image-gathering device that produces data representing the implant. In a specific example of implementation, the processing may include adding image elements that represent mechanical features for facilitating the affixation of the implant to the bone or mechanical features allowing affixation of one or more discrete components to the implant. Examples of mechanical features include spikes that project at least partly in a direction opposite to the direction of insertion of the implant into the alveolar bone.

In a specific example of implementation, the area inside the patient's mouth is a cavity in the alveolar bone, such as a tooth cavity.

In accordance with a fourth broad aspect, the invention provides a method comprising making a cast of an area in the patient's mouth, electronically examining the cast to obtain an electronic representation of the cast and delivering data derived from the electronic representation to a remote location for use in manufacturing an implant adapted to fit the area. The cast of the area of interest can be done in a number of ways all of which are encompassed under the present inventive concept. For example, the cast can be made by introducing a liquid substance in or on the area of interest and letting the substance harden. Alternatively, the cast can be made by creating an impression of the area of interest in a malleable substance capable of being formed by the application of pressure.

As in the case of the third broad aspect, the fourth broad aspect encompasses a number of possibilities. Under a first possibility, the data derived from the electronic representation is the raw data generated from a suitable electronic image-gathering device used to electronically examine the cast, or a variation of the raw data. By “variation” is meant a treatment of the raw data that can be of any type as long as it preserves the information of the surface features of the cast required to produce the implant. Examples of a variation of the raw data include compressing the raw data, encrypting the raw data, translating the data from one type of representation to another type of representation, or performing a pre-processing such as enhancing or cleaning-up the image by any suitable image processing techniques.

The delivery of this data derived from the electronic representation of the cast to the remote location can be done via a communications network or by storing the data on a storage medium and transporting the storage medium, by courier, postal service or any other means, to the remote location.

Under a second possibility, the data derived from the electronic representation of the cast is data resulting from a processing of the raw data generated from the image-gathering device that produces data representing the implant. For example, the processing may include adding image elements that represent mechanical features for facilitating the affixation of the implant to the bone or mechanical features allowing affixation of one or more discrete components to the implant. Examples of mechanical features include spikes that project at least partly in a direction opposite to the direction of insertion of the implant into the alveolar bone.

Under a fifth broad aspect, the invention provides a method for providing a dental implant, comprising electronically examining an area inside a patient's mouth to obtain an electronic representation of the area and using the electronic representation to manufacture an implant adapted to fit the area.

Under a sixth broad aspect, the invention provides a method for providing a dental implant, comprising making a cast of an area of interest in the patient's mouth, electronically examining the cast to obtain an electronic representation of the area and using the electronic representation to manufacture an implant adapted to fit the area.

Under a seventh broad aspect, the invention provides a method for the production of a dental implant, comprising receiving encrypted data representing a dental implant via a communications network, re-encrypting the data representing the dental implant and delivering the re-encrypted data representing the dental implant to a production facility for remote manufacture of the dental implant.

Under an eighth broad aspect, the invention provides computer-readable media tangibly embodying a program of instructions executable by a computer to perform a method for the production of a dental implant. The method comprises receiving encrypted data representing a dental implant via a communications network, re-encrypting the data representing the dental implant and delivering the re-encrypted data representing the dental implant to a production facility for remote manufacture of the dental implant.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the drawings:

FIG. 1 is a flowchart illustrating various steps in a method of manufacturing a dental implant in accordance with an embodiment of the present invention;

FIG. 2 diagrammatically illustrates the interrelation of the steps in the flowchart of FIG. 1; and

FIGS. 3A and 3B show alternative embodiments of step 110 in FIG. 1.

### DETAILED DESCRIPTION OF PREFERRED EMBODIMENTS

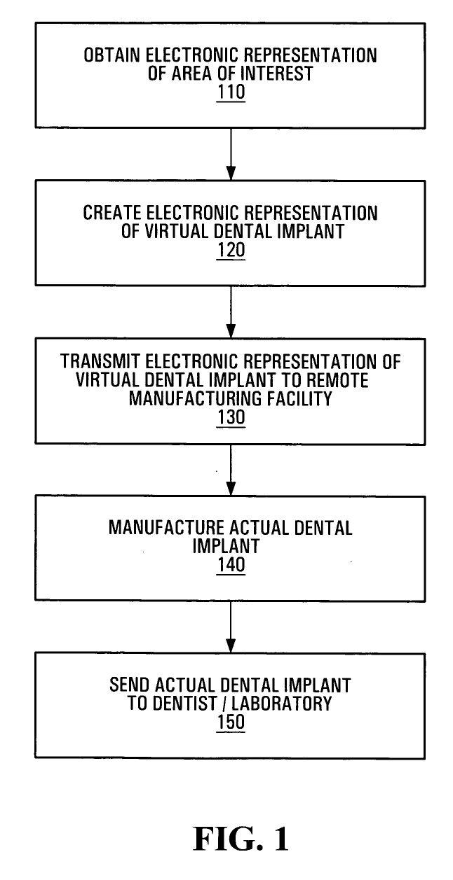

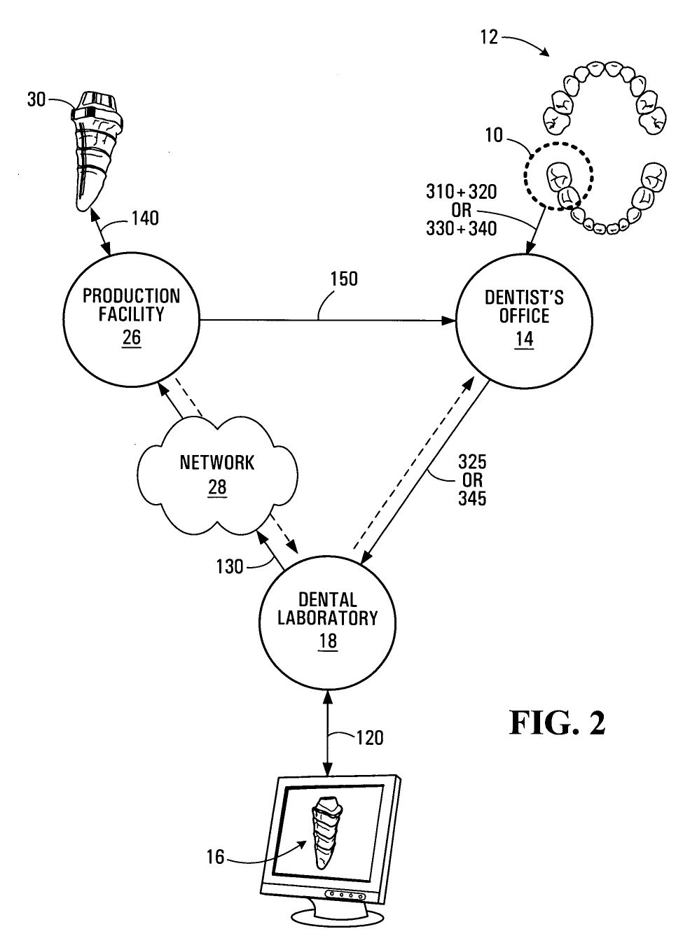

With reference to FIGS. 1 and 2, step 110 in a method according to an example embodiment of the present invention comprises obtaining an electronic representation of an area of interest 10 inside a patient's mouth 12. This step can be performed at a dentist's office or clinic 14 or at the dental laboratory 18. Since extraction/loss of a tooth will leave behind a socket in the patient's alveolar bone, the area of interest 10 may thus correspond to this tooth socket. In other embodiments, the dentist may drill into an existing bone, which forms a hole that becomes the area of interest 10 where placement of an implant is desired. However, it should be understood that these two examples of area of interest do not limit the scope of the present invention, which is equally applicable to any region where a customized implant can be fixed in the patient's mouth.

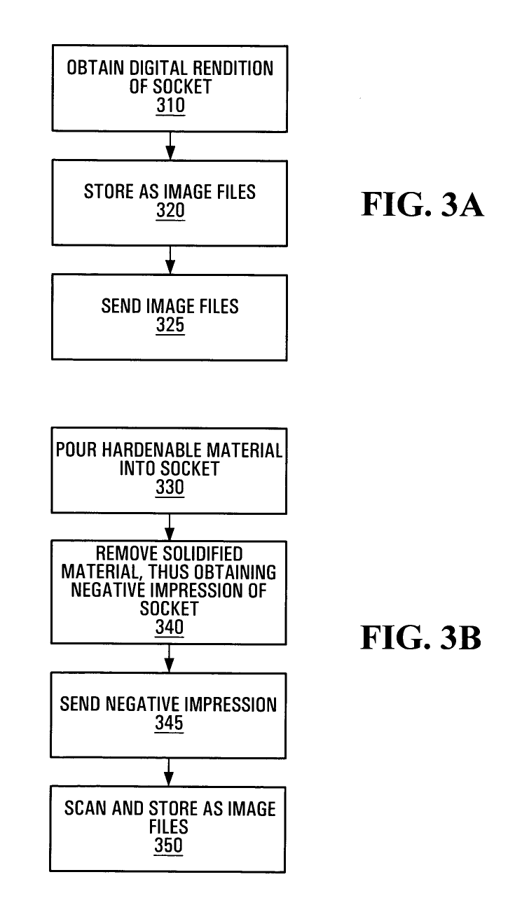

There exist various ways in which the electronic representation of the area of interest 10 may be obtained at step 110, some of which are described in the following. With reference to FIG. 3A, an electronic representation of the area of interest 10 is obtained directly, in “positive” form. Specifically, at step 310, the electronic representation is obtained by performing an electronic examination of the area interest. Step 310 can be performed at the dentist's office 14 by the dentist or dentist's assistant.

The electronic examination translates an optical image of the area of interest into an electronic representation of this optical image. The electronic representation may be a collection of data elements, such as a computer file, in the form of a three-dimensional model of the area of interest. In a specific example of implementation, the electronic examination of the area of interest 10 includes examining the area of interest from various angles of elevation and azimuth with an image-gathering device such as a device sensitive to reflection of a laser or a charge-coupled device (CCD) such as a digital camera, or the like.

In addition to using an image-gathering device that provides external images of the area of interest, it can also be envisaged to perform the electronic examination by using an image-gathering device that can provide images of internal organs of the human body. Examples of such image-gathering device include an x-ray machine that can gather one or more x-ray images of the patient's mouth from which the electronic representation can be derived. Alternatively, the image-gathering device can be a Computerized Axial Tomography (CAT) scanner, magnetic resonance scanner or any other suitable internal image-gathering device.

It should be expressly noted that that the invention is not limited to any particular apparatus or technique used to perform the electronic examination of the area of interest.

At step 320, the raw data generated as a result of the electronic examination of the area of interest is stored as on a computer readable storage medium such as a diskette, hard disk, memory stick, card, cassette, etc. At step 325, data derived from the electronic representation of the area of interest is subsequently delivered to a dental laboratory 18 for further processing. The data derived from the electronic representation is the raw data generated by the electronic image-gathering device used to perform the electronic examination, or a variation of the raw data.

The transmission of the data derived from the electronic representation can be done by way of a transfer of computer files over a network such as the Internet, a local area network (LAN) or the public switched telephone network (PSTN).

The data transfer may also occur through the use of computer-readable medium such as a diskette, CD-ROM, etc. Specifically, the computer readable storage medium can be physically transported to the dental laboratory by any convenient way such as by courier service or postal service, among other possibilities.

Alternatively, with reference to FIG. 3B, an electronic representation of the area of interest 10 is obtained in “negative” form. Specifically, at step 330, a cast of the area of interest 10 is formed at the dentist's office 14. This can be achieved by introducing in or over the area of interest, such as by pouring, a non-toxic, hardenable material (e.g., vinyl, polysiloxane), which is allowed to cure and become solid. At step 340, the solid material is removed, at which point it will be appreciated that the solid cast forms a substantially accurate negative impression of the area of interest 10. At step 350, an electronic examination of the cast is obtained, e.g., by way of any suitable image-gathering device. At step 360, the raw data generated by the image-gathering device is stored on a computer readable storage medium such as a diskette, hard disk, memory stick, card, cassette, etc. It should be noted that steps 350 and 360 can be performed at the dentist's office 14, following which data derived from the electronic representation of the cast, or a variation thereof is sent to the dental laboratory 18. However, it is also possible to perform steps 350 and 360 at the dental laboratory itself, and therefore the cast needs to be sent to the dental laboratory 18 at step 345.

Returning now to FIGS. 1 and 2, once the electronic representation of the area of interest has been obtained, step 120 provides for processing the electronic representation of the area of interest 10 in order to create data representing a dental implant 16 adapted to fit into the area of interest 10. While step 110 is performed either at the dentist's office 14 or at the dental laboratory 18 (or at a combination of both), step 120 would typically be performed at the dental laboratory 18 where specialized computer assisted design (CAD) software is available. Of course, the dental laboratory 18 and the dentist's office 14 may be collocated or remote from one another.

The specialized CAD software provides functionality required for creating the data representing the dental implant 16. It has an interface that leads a dental technician step by step in the creation process, and may include various features such as three-dimensional imaging from a desired perspective, alteration/addition of features and so on.

At the dental laboratory 18, CAD software is used to design the implant based on the area of interest 10 from the electronic representation obtained at step 110. The result of this computer assisted design procedure is data representing a dental implant 16. The data representing the dental implant may include additional image elements that represent mechanical features for facilitating the affixation of the implant to the bone or mechanical features allowing affixation of one or more discrete components to the implant. Examples of mechanical features include but are not limited to spikes that project at least partly in a direction opposite to the direction of insertion of the implant into the alveolar bone.

At step 130, the data representing the dental implant 16 is transmitted to a production facility 26 via a communications network 28. A suitable example of the communications network 28 is the Internet, a LAN or the PSTN. In an embodiment, the data representing the dental implant 16 is encrypted before being sent on the communications network 38. This data, as well as data from other dental laboratories, is sent to a control center (not shown) comprising a server that computes the number of dental implant units requested/produced by each laboratory. The data representing the various dental implants will then be re-encrypted by the server at the control center and sent to the most convenient production facility (e.g., production facility 26), along with customer information. By using different encryption systems for the communication between the dental laboratory 18 and the control center and for the communication between the control center and the production facility 26, it can be ensured that the dental laboratory 18 will not have to capacity to bypass the control center. Alternatively, the data representing the dental implant can be sent to the production facility 26 by storing the data on a computer readable storage medium and sending the computer readable storage medium via courier or postal service to the production facility 26. Of note is the fact that the production facility 26 can be remote from the site where the electronic representation of the area of interest 10 is obtained and also remote from the site at which the electronic representation of the virtual dental implant has been designed. Thus, the production facility 26 may be remote from any or both of the dentist's office 14 and the dental laboratory 18.

In summary, once the electronic representation of the area of interest in the patient's mouth has been obtained, data derived from this representation is sent to a remote location for use in manufacturing the implant fitting the area of interest. In one specific example of implementation, the remote location is the dental laboratory, which produces data representing the implant. In a second example of implementation, the remote location is the actual production facility where the implant is manufactured. Accordingly, the data derived from the electronic representation that is transmitted to the remote location in the second example is the data representing the implant, such that little or no further data processing is required at the remote location.

It should be expressly noted that the present invention also covers implementations where the dentist office, the dental laboratory and the production facility are located at the same place. In such instance, the transmission involved between the various image-gathering and data processing entities is of local nature.

At the production facility 26, a computer-controlled manufacturing device can be instructed or directed to produce an actual dental implant 30 on the basis of the data representing the dental implant 16. A non-limiting example of a suitable device for use at the production facility 26 is a computer-controlled milling machine that creates the actual dental implant 30 from a biologically compatible material (e.g., titanium). Of course, other devices, materials or fabrication techniques may be used by those of ordinary skill in the art and such variations are within the scope of the present invention. In general, it should be noted that the production process may be fully or partially automated. In a fully automatic scenario, receipt of the data representing the dental implant 16 triggers a fabrication process without human intervention. In a partially automated environment, the received data representing the dental implant 16 may be verified by a technician to ensure that all the required information is present; the technician may subsequently set the controls on the fabrication device in accordance with the received information (e.g., 3D-model).

Upon production, the actual dental implant 30 may be sterilized and then sent (e.g., via mail or messenger) to the dentist's office 14. The implant is then sterilized (or sterilized a second time) by the dentist prior to surgery. In an alternative embodiment, the actual dental implant 30 is sent to the dental laboratory 18 for inspection prior to being shipped to the dentist's office 14.

Thus, it can be appreciated that the present invention may shorten the duration of the process for manufacturing a customized dental implant. The whole production process may take anywhere from three to seven days or less, from the day of the extraction/loss of the tooth to the day of the insertion of the actual dental implant 30. Also, there are fewer manual tasks in the process, leading to a reduced incidence of fabrication errors.

Those skilled in the art will appreciate that in some embodiments, functional units (e.g., servers) performing various methods may be implemented as pre-programmed hardware or firmware elements (e.g., application specific integrated circuits (ASICs), electrically erasable programmable read-only memories (EEPROMs), etc.), or other related components. In other embodiments, the functional units may be implemented as an arithmetic and logic unit (ALU) having access to a code memory (not shown) which stores program instructions for the operation of the ALU. The program instructions could be stored on a medium which is fixed, tangible and readable directly by the functional units, (e.g., removable diskette, CD-ROM, ROM, or fixed disk), or the program instructions could be stored remotely but transmittable to the functional units via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

While specific embodiments of the present invention have been described and illustrated, it will be apparent to those skilled in the art that numerous modifications and variations can be made without departing from the scope of the invention as defined in the appended claims.

1. A method of commissioning a customized dental implant, comprising:
obtaining an electronic representation of an area of interest inside a patient's mouth;
processing the electronic representation to create data representing a dental implant adapted to fit the area of interest;
delivering the data representing the dental implant to a production facility for remote manufacture of the dental implant.

2. The method defined in claim 1, wherein the area of interest is a socket in an alveolar bone.

3. The method defined in claim 1, wherein said obtaining includes performing an electronic examination of the area of interest.

4. The method defined in claim 1, wherein said obtaining is performed at a patient location and wherein said processing is performed at a laboratory, wherein the method further comprises, between said obtaining and said processing:
delivering data derived from the electronic representation from the patient location to the laboratory.

5. The method defined in claim 4, wherein said delivering is achieved electronically.

6. The method defined in claim 1, wherein said obtaining includes:
obtaining a cast of the area of interest;
electronically examining the cast to obtain the electronic representation of the area of interest.

7. The method defined in claim 1, wherein said obtaining includes:
obtaining a cast of the area of interest at a patient location;
sending the cast from the patient location to a laboratory;
electronically examining the cast to obtain the electronic representation of the area of interest.

8. The method defined in claim 7, wherein said sending is achieved via mail or messenger.

9. The method defined in claim 1, wherein the electronic representation of the area of interest is embodied as a three-dimensional model of the area of interest stored on a computer-readable medium.

10. The method defined in claim 1, wherein said processing comprises using computer assisted design (CAD) software to create the data representing the dental implant.

11. The method defined in claim 1, wherein said delivering is done over the Internet.

12. The method defined in claim 1, further comprising using the data representing the dental implant for manufacturing the dental implant.

13. The method defined in claim 12, wherein said obtaining and said processing are performed at a site remote from the production facility and connected thereto via a communications network.

14. A method for the production of a dental implant, comprising:
receiving data representing a dental implant via a communications network; and
using the data to manufacture the dental implant.

15. The method defined in claim 14, wherein the data representing the dental implant is received from a source, the method further comprising:
sending the manufactured dental implant to a desired destination.

16. The method defined in claim 15, wherein the source is a dental laboratory.

17. The method defined in claim 15, wherein the destination is a dental laboratory.

18. The method defined in claim 16, wherein the destination is a dentist's clinic.

19. The method defined in claim 18, further comprising, prior to said sending:
inspecting the dental implant at the dental laboratory.

20. The method defined in claim 15, wherein said sending is achieved via mail or messenger.

21. A method in the manufacture of a dental implant, comprising:
electronically examining an area inside a patient's mouth to obtain an electronic representation of the area, and
delivering data derived from the electronic representation to a remote location for use in manufacturing the dental implant adapted to fit the area.

22. A method as defining in claim 21, wherein the area is a socket in an alveolar bone.

23. A method as defined in claim 22, wherein the socket is a tooth socket.

24. A method as defined in claim 23, wherein said delivering includes electronically transmitting the data to the remote location.

25. A method as defined in claim 23, wherein the data derived from the electronic representation is data representing the dental implant.

26. A method in the manufacture of a dental implant, comprising:
making a cast of an area in the patient's mouth;
electronically examining the cast to obtain an electronic representation of the cast, and
delivering data derived from the electronic representation to a remote location for use in manufacturing the dental implant adapted to fit the area.

27. A method as defined in claim 26, wherein the area is a socket in an alveolar bone.

28. A method as defined in claim 27, wherein the socket is a tooth socket.

29. A method as defined in claim 28, said delivering includes electronically transmitting the data to the remote location.

30. A method as defined in claim 29, wherein the data derived from the electronic representation is data representing the dental implant.

31. A method for providing a dental implant, comprising:
electronically examining an area inside a patient's mouth to obtain an electronic representation of the area, and
using the electronic representation to manufacture the dental implant adapted to fit the area.

32. A method as defining in claim 31, wherein the area is a socket in an alveolar bone.

33. A method as defined in claim 32, wherein the socket is a tooth socket.

34. A method for providing a dental implant, comprising:
making a cast of an area of interest in the patient's mouth;
electronically examining the cast to obtain an electronic representation of the area of interest, and
using the electronic representation to manufacture the dental implant adapted to fit the area of interest.

35. A method as defining in claim 33, wherein the area is a socket in an alveolar bone.

36. A method as defined in claim 34, wherein the socket is a tooth socket.

37. A method for the production of a dental implant, comprising:
receiving encrypted data representing a dental implant via a communications network;
re-encrypting the data representing the dental implant;
delivering the re-encrypted data representing the dental implant to a production facility for remote manufacture of the dental implant.

38. A method as defined in claim 37, wherein the re-encrypted data representing the dental implant differs from the received encrypted data representing the dental implant.

39. A method as defined in claim 38, wherein re-encrypting the data representing the dental implant comprises encrypting the encrypted data representing the dental implant.

40. A method as defined in claim 38, further comprising:
decrypting the data representing the dental implant prior to re-encrypting the data representing the dental implant.

41. A method as defined in claim 37, wherein the data representing the dental implant is received from a first customer, the method further comprising:
receiving encrypted data representing a second dental implant from a second customer via the communications network;
re-encrypting the data representing the second dental implant;
delivering the re-encrypted data representing the second dental implant to said production facility for remote manufacture of the second dental implant.

42. Computer-readable media tangibly embodying a program of instructions executable by a computer to perform a method for the production of a dental implant, the method comprising:
receiving encrypted data representing a dental implant via a communications network;
re-encrypting the data representing the dental implant;
delivering the re-encrypted data representing the dental implant to a production facility for remote manufacture of the dental implant.
